(19) United States
(12) Patent Application Publication
(10) Pub. No.: US 2006/0083115 A1
(43) Pub. Date: Apr. 20, 2006

(54) Flexible band with clip-on watch

(76) Inventors: Ronald Lafever, Laguna Beach, CA (US); William C. Green, Charlotte, NC (US); Guy Johnson, Irvine, CA (US); Jon Christopher Lake, Sunnyvale, CA (US); Hiroshi Ono, Via Buozzi Bruno (IT)

Correspondence Address: BELASCO, JACOBS & TOWNSLEY LLP;HOWARD HUGHES CENTER, 6100 CENTER DRIVE, SUITE 630, LOS ANGELES, CA, 90045, US

(21) Appl. No.: 11/293,472

(22) Filed: Dec. 2, 2005

(51) Int. Cl. G04B 37/00

(52) U.S. Cl. 368/282

(57) ABSTRACT

A flexible band with clip-on watch module includes a band, a watch movement, a display, a surrounding case and an attachment mechanism. The attachment mechanism has several embodiments. These include a channel beneath the case comprised of two pair of opposed prongs; an elastic member passed beneath the band and the case and secured to ridges on the top surface of the case; an underband platform suspended from the case with retaining members at a side edge; a hingedly attached retaining clip that encloses the band and snaps onto a side of the case; one or more lateral slots in a side edge of the case into which the band is inserted; and a curved support platform under the watch module with retaining notches at either end for retention of a folded and flattened band. The case, recess, channel and attachment mechanism may be curved to better fit the wrist.

### FIELD OF INVENTION

The invention pertains to watches. More particularly, the invention relates to modular watches designed to attach to continuous flexible bands.

### BACKGROUND OF THE INVENTION

With seven Tour de France victories, the story of Lance Armstrong and his battle with cancer has become a popular cause. Those supporting this cause do so by purchasing and wearing yellow plastic wrist bracelets. A charitable donation is made as a portion of the purchase price. Tens of millions of these bracelets have been sold and bracelets of other colors have been sold in association with other charitable causes. The present invention relates to a watch module designed to attach to these plastic wrist bracelets. Many designs have been developed for attaching a watch to a watch band, however, there are very few designs for attachment of a watch to a continuous flexible band, i.e., one without a closure means.

U.S. Pat. No. 6,130,861, issued to Della Felice, discloses a watch case with a retaining means which is hinged at one end to the case by a hinge extending transversely with respect to the line of the strap, at a limited distance from the rear surface of the case in order to allow the strap to be passed through. The retaining means can be closed against the case in order to grip the strap (which is thus easy to replace) and is positionable at a limited angle with respect to the case, such that it can be stood on a surface like a little table-top clock.

U.S. Pat. No. 5,491,984, issued to Loch is directed to a ring-shaped member for hand wear. The ring-shaped member is to be worn on the hand of the individual and is band type structure having first and second ends for closure. In one embodiment of the invention a time piece may be attached to the ring shaped member.

U.S. Patent Publication No. 2005/0022554, by Davidson et al. discloses a bracelet with interchangeable adornments for storing medications, hygiene products, or food. The bracelet with interchangeable adornments has a strap and a container. The container attaches to the strap via a fastening means. Furthermore, the container has a base and a lid. The lid is coupled to the base via a movable member. The movable member prevents the lid from detaching from the base while enabling the lid to open and close. The base is hollow and is generally geometric in shape or generally represents an object that is flower-like, person-like, or animal-like.

U.S. Pat. No. 2,541,432, issued to Muehlbauer describes a compass attachment for wristwatch straps and bands. The compass is attached to the band by means of a clip.

U.S. Pat. No. 3,739,740, issued to Fromer is directed to a wrist mounted pill box. A watch is attached to a band by means of flexible extensions which are secured to a lower container portion so that they can be bent under the wrist band or strap.

U.S. Pat. No. 4,326,280, issued to Perry, Jr. describes a device for convenient mounting of a wrist watch on a belt. The watch is mounted within a case having a belt bracket and a hinged protective cover. The watch is hingedly mounted on one of its conventional strap pins to the inside of the protective cover. Both hinged mountings are spring biased to urge the protective cover and watch to a normal closed position. The other conventional strap pin of the watch retains a strap which hangs freely from the case, to provide a convenient handle to open the case and pull the watch into view.

U.S. Pat. No. 4,862,436, issued to Harilela describes a watch and strap combination in which the strap is essentially constituted by an elongate rectangular strip of paper material of weight between 150 and 350 g/m.sup.2, carrying printed matter under an optional PVC lamination. Means for fastening together the strap ends may include a double-sided adhesive patch or a touch-and-close fastener.

U.S. Pat. No. 3,797,148, issued to Ivengsberg et al. is directed to an arrangement in or relating to a year calendar. The calendar is attached to a band by means of securing clips which are bent inwardly at the lower surface of the strap.

U.S. Pat. No. 4,542,630, issued to Nanasi discloses a flexible, elongated band that has a removable ornament thereon that can be intentionally removed from the band but cannot be accidentally removed.

It is an objective of the present invention to provide a mechanism for attaching a watch to a flexible continuous wrist band. It is a further objective to provide a mechanism that will provide a secure attachment while permitting relatively easy removal of the watch from the band. It is a still further objective of the invention to provide an attachment mechanism that can be used with watches of different sizes. Finally, it is an objective to provide a watch and band combination based upon flexible, continuous bands that is simple and inexpensive to produce and durable in nature.

While some of the objectives of the present invention are disclosed in the prior art, none of the inventions found include all of the requirements identified.

### SUMMARY OF THE INVENTION

The present invention addresses all of the deficiencies of prior art clip-on watch inventions and satisfies all of the objectives described above.

(1) A flexible band with clip-on watch can be fabricated from the following components. At least one flexible, continuous band is provided. The band has a first predetermined width and a first predetermined thickness, is formed of resilient material and is sized and shaped to fit stretchably over a wearer's hand and loosely about the wearer's wrist. A watch module is provided. The watch module includes a time-keeping movement, a display, a surrounding case, and an attachment mechanism. The case has an upper surface and a lower surface. The attachment mechanism removably joins the watch module to the band.

(2) In a variant of the invention, the attachment mechanism further includes first and second retaining clips. Each of the clips extends outwardly from the surrounding case along a diameter of the watch module in opposite directions. Each of the clips has a channel through it. The channel has an upper wall, a lower wall and is sized and shaped to fit slidably about the band. The lower wall includes first and second opposing prongs. The prongs are located at right angles to the diameter and extend inwardly from outer edges of the clips toward each other. The prongs are spaced apart sufficiently to permit an edge of the band to pass between them. When the edge of the band is passed between each of the sets of prongs and turned to lie flat against the lower surface of the surrounding case, the band will be removably attached to the watch module.

(3) In another variant, the watch module further includes a bottom plate. The bottom plate is attached to the lower surface of the surrounding case and forms the upper wall of the channel. The lower wall includes the first and second opposing prongs descending from side edges of the bottom plate.

(4) In still another variant, the bottom plate is curved to permit the watch module to fit more closely against the wrist of the wearer.

(5) In yet another variant, the upper wall of the channel is recessed into the lower surface of the surrounding case, thereby permitting the band to fit more closely against the wrist of the wearer.

(6) In a further variant, the watch module includes an analog watch movement.

(7) In still a further variant, the watch module includes a digital watch movement.

(8) In yet a further variant, the watch module is waterproof.

(9) In a variant of the invention, the attachment mechanism further includes at least one first side wall. The first side wall is attached at a right angle to the lower surface of the surrounding case and descends from it for a first predetermined distance. At least one underband plate is provided. The plate is attached at a right angle at a proximate edge to a lower edge of the first side wall. The plate has a width at least equal to the first predetermined width and is spaced from the lower surface by at least the first predetermined thickness. At least one second side wall is provided. The second side wall is attached at a right angle at a distal edge of the underband plate and ascends toward the lower surface for at least the first predetermined distance. At least one retaining tab is provided. The retaining tab is attached at a right angle at an upper edge of the second side wall and extends inwardly over the underband plate for a second predetermined distance. When the band is inserted between the lower surface of the surrounding case and the underband plate it will be located against the first side wall and when the band is then pushed under the retaining tab it will be located between the first side wall and the second side wall, thereby removably attaching the watch module to the band.

(10) In another variant, the underband plate is curved to permit the watch module to fit more closely against the wrist of the wearer.

(11) In still another variant, the lower surface of the surrounding case is recessed, thereby providing a space for the band and permitting the watch module to fit more closely against the wrist of the wearer.

(12) In yet another variant, the attachment mechanism further includes first and second retaining means. The retaining means extend upwardly from the upper surface of the surrounding case. A continuous loop is provided. The loop is formed of resilient material and is sized and shaped to extend from an inner edge of the first retaining means, beneath the lower surface of the watch module and the continuous band, and over an inner edge of the second retaining means, thereby removably attaching the watch module to the band.

(13) In a further variant, the attachment mechanism further includes a recess. The recess is located in the lower surface of the surrounding case, is sized and shaped to fit frictionally about the band and permits the watch module to fit more closely against the wrist of the wearer.

(14) In still a further variant, the lower surface of the surrounding case and the recess are curved, thereby permitting the watch to fit more closely against the wrist of the wearer.

(15) In yet a further variant, the retaining means further includes first and second ridges. The ridges are sized and shaped to retain the continuous loop.

(16) In another variant of the invention, the attachment mechanism further includes at least one side notch. The side notch extends downwardly from ends of the first and second ridges along side edges of the surrounding case. The notches make attachment of the continuous loop more compact.

(17) In still another variant, the attachment mechanism further includes an attachment bracket. The bracket is formed of resilient material, hingedly attached at a first end adjacent a first side of the lower surface of the surrounding case and removably attached at a second end adjacent an opposite second side of the lower surface. The bracket is spaced downwardly from the lower surface by a distance slightly less than the first predetermined thickness. The bracket bears frictionally against the band when the second end is attached adjacent the opposite second side of the lower surface. When the second end of the bracket is detached from adjacent the opposite second side, the watch module may be removed from the band.

(18) In yet another variant, the first end of the bracket is hingedly attached at a first point on a first side edge of the surrounding case. The bracket descends from the first point below the lower surface of the case, extends across the lower surface and ascends to a second point on an opposite second side edge of the case. The second end of the bracket is removably attached to the second side edge adjacent the second point.

(19) In a further variant, the attachment mechanism further includes a recess. The recess is located in the lower surface of the surrounding case, is sized and shaped to fit frictionally about the band and permits the watch module to fit more closely against the wrist of the wearer.

(20) In still a further variant, the lower surface of the surrounding case and the recess are curved, thereby permitting the watch to fit more closely against the wrist of the wearer.

(21) In yet a further variant, the attachment mechanism further includes an elastic member. The member has a first predetermined cross section, is sized and shaped to fit elastically about a peripheral edge of the surrounding case, under the lower surface of the case, across the band and back over the peripheral edge. A circumferential groove is provided. The groove is located about the peripheral edge of the surrounding case and is sized and shaped to retain at least one cross section of the elastic member. When the elastic member is looped about the circumferential groove and passed under the lower surface of the surrounding case, under the band and back up and over the case and stretched over the groove, the watch module will be removably attached to the band.

(22) In another variant of the invention, the attachment mechanism further includes a recess. The recess is located in the lower surface of the surrounding case, is sized and shaped to fit frictionally about the band and permits the watch module to fit more closely against the wrist of the wearer.

(23) In still another variant, the lower surface of the surrounding case and the recess are curved, thereby permitting the watch to fit more closely against the wrist of the wearer.

(24) In yet another variant, the elastic member includes two circular portions. The circular portions are sized and shaped to fit elastically about the circumferential groove. The circular portions are joined at their peripheral edges by at least one straight member. The straight member is sized to extend elastically from the first circular portion, under the lower surface of the surrounding case, under the band and back to the peripheral edge of the second circular portion.

(25) In a further variant, the attachment mechanism further includes at least one slot. The slot extends from a front edge of the surrounding case to a rear edge of the case, has an opening at a side edge of the case and is sized and shaped to fit frictionally about the band. When the band is inserted into the slot, the watch module will be removably attached to the band.

(26) In still a further variant, the opening is slightly smaller than the first predetermined thickness. When the band is inserted into the slot, slight pressure will be required to force the band past the opening and into the slot, thereby securing the watch module to the band.

(27) In yet a further variant, the attachment mechanism further includes first and second parallel slots. The slots are located above the lower surface of the surrounding case. Each of the slots has an opening at an adjacent side edge of the case. Two bands are provided. Each of the bands is disposed in one of the first and second slots.

(28) In another variant of the invention, the lower surface of the surrounding case is curved, thereby permitting the watch to fit more closely against the wrist of the wearer.

(29) In still another variant, the attachment mechanism further includes a curved support platform. The platform has a first end and a second end. Each of the ends extends outwardly adjacent first and second side edges of the lower surface of the surrounding case, is curved to conform to the wrist of the wearer, and has a width at least equal to the first predetermined width. First and second attachment notches are provided. Each of the notches is located adjacent one of the first and second ends of the support platform and is sized and shaped to retain a folded loop of the flexible, continuous band. When a folded loop of the band is inserted into to each of the first and second attachment notches, the watch module will be removably attached to the folded band.

(30) In yet another variant, each of the attachment notches includes an aperture located adjacent each of the first and second ends of the support platform. A retaining member is provided. The retaining member extends from a proximal end attached to a lateral inside edge of the aperture toward an opposite lateral inside edge. A distal end of the retaining member is spaced from the opposite edge by at least the first predetermined thickness. When the folded loop of the flexible, continuous band is inserted into each of the apertures and about the retaining member, the watch module will be removably attached to the folded band.

(31) In a further variant, each of the attachment notches includes an opening. The opening extends from a first edge of the curved support platform toward a second opposite edge of the platform. The opening defines a retaining member disposed at a distal end of the support platform, the retaining member is spaced outwardly from the opening by at least the first predetermined thickness. When the folded loop of the flexible, continuous band is disposed through the opening and about each of the retaining members the watch module will be removably attached to the folded band.

(32) In still a further variant of the invention, each of the retaining members is attached to the second edge of the support platform at an acute angle, thereby more securely attaching the watch module to the folded band.

(33) In yet a further variant, the attachment mechanism further includes an attachment bracket. The bracket is formed of resilient material, hingedly attached at a first end adjacent a first side of the lower surface of the surrounding case and removably attached at a second end adjacent an opposite second side of the upper surface of the case. The bracket is spaced downwardly from the lower surface by a distance slightly less than the first predetermined thickness. The bracket bears frictionally against the band when the second end is attached adjacent the opposite second side of the upper surface. When the second end of the bracket is detached from adjacent the opposite second side, the watch module may be removed from the band.

(34) In another variant, the first end of the bracket is hingedly attached at a first point on the first side edge of the surrounding case. The bracket descends from the first point below the lower surface of the case, extends across the lower surface and ascends to a second point on an opposite second side of the upper surface of the case. The second end of the bracket is removably attached to the upper surface adjacent the second point.

(35) In still another variant, the attachment mechanism further includes a recess. The recess is located in the lower surface of the surrounding case, is sized and shaped to fit frictionally about the band and permits the watch module to fit more closely against the wrist of the wearer.

(36) In a final variant of the invention, the lower surface of the surrounding case and the recess are curved, thereby permitting the watch to fit more closely against the wrist of the wearer.

An appreciation of the other aims and objectives of the present invention and an understanding of it may be achieved by referring to the accompanying drawings and the detailed description of a preferred embodiment.

### DESCRIPTION OF THE DRAWINGS

FIG. 1 is a perspective view of a first embodiment of the invention illustrating an analog watch module with prong-type attachment mechanism;

FIG. 2 is a side elevational view of the FIG. 1 embodiment illustrating passage of the continuous band through the attachment mechanism;

FIG. 2A is a side elevational view of the FIG. 1 embodiment illustrating a surrounding case having a curved lower surface;

FIG. 2B is a side elevational view of the FIG. 1 embodiment illustrating a surrounding case having a curved bottom plate;

FIG. 3 is a bottom view of the FIG. 1 embodiment illustrating the prong-type attachment mechanism;

FIG. 3A is a bottom view of the FIG. 1 embodiment illustrating a recessed channel in the lower surface of the surrounding case;

FIG. 4 is a perspective view of a second embodiment of the invention illustrating a digital watch movement and prong-type attachment mechanism;

FIG. 5 is a side elevational view of the FIG. 4 embodiment illustrating passage of the continuous band through the attachment mechanism;

FIG. 6 is a perspective view of the watch module of the FIG. 4 embodiment illustrating the prong-type attachment mechanism and a channel in the lower surface of the surrounding case;

FIG. 7 is a perspective view of a third embodiment of the invention illustrating an analog watch movement and elastic member-type attachment mechanism;

FIG. 8 is a top view of the FIG. 7 embodiment with a partial section illustrating attachment ridges on an upper surface of the surrounding case;

FIG. 9 is a side elevational view of the FIG. 7 embodiment illustrating a curved watch module and a recess the lower surface of the case;

FIG. 10 is a bottom view of the FIG. 7 embodiment illustrating a recess the lower surface of the case;

FIG. 11 is a perspective view of a fourth embodiment of the invention illustrating an analog watch movement and underband plate-type attachment mechanism;

FIG. 12 a side elevational view of the FIG. 11 embodiment illustrating a curved underband plate;

FIG. 13 is a top view of the FIG. 11 embodiment illustrating the underband plate and two retaining tabs;

FIG. 14 a side elevational view of the FIG. 11 embodiment illustrating a curved underband plate; and a recess in the lower surface of the watch module;

FIG. 15 is a perspective view of a larger version of the FIG. 11 embodiment illustrating a watch module having two underband plates and retaining tabs on each side of the surrounding case;

FIG. 16 a bottom view of the FIG. 15 embodiment illustrating the two underband plates;

FIG. 17 a side elevational view of the FIG. 15 embodiment illustrating a curved underband plate;

FIG. 18 is a perspective view of a fifth embodiment of the invention illustrating a hinged clip-type attachment mechanism in an open position;

FIG. 19 is a side elevational view of the FIG. 18 embodiment of the invention illustrating a hinged clip-type attachment mechanism pivoting at the side of the lower surface of the surrounding case and fastening on the upper surface of the case;

FIG. 19A is a side elevational view of the FIG. 18 embodiment of the invention illustrating a hinged clip-type attachment mechanism pivoting at the side of the surrounding case and fastening on the upper surface of the case;

FIG. 20 is a side elevational view of the FIG. 18 embodiment of the invention illustrating a hinged clip-type attachment mechanism pivoting at the side of the surrounding case and fastening on the side of the case;

FIG. 21 is a side elevational view of the FIG. 18 embodiment of the invention illustrating a hinged clip-type attachment mechanism pivoting at the side of the lower surface of the surrounding case and fastening at an opposite side of the lower surface of the case;

FIG. 22 is a perspective view of the FIG. 18 embodiment of the invention illustrating a channel in the curved lower surface of the surrounding case;

FIG. 23 is a perspective view of a sixth embodiment of the invention illustrating a watch module with a circumferential groove and elastic member attachment means;

FIG. 24 is a perspective view of the FIG. 23 embodiment of the invention illustrating the attachment of the elastic member;

FIG. 25 is a perspective view of the FIG. 23 embodiment of the invention illustrating the elastic member attached to the circumferential groove;

FIG. 26 is a perspective view of a seventh embodiment of the invention illustrating a dual band side opening attachment mechanism;

FIG. 27 is a perspective view of the watch module of the FIG. 26 embodiment of the invention illustrating the side openings of the attachment mechanism;

FIG. 28 is a perspective view of FIG. 26 embodiment of the invention illustrating a curved watch module;

FIG. 29 is a perspective view of the FIG. 26 embodiment of the invention illustrating a curved watch module for a single band;

FIG. 30 is a perspective view of an eighth embodiment of the invention illustrating a curved watch module with an attachment mechanism for a folded flexible band;

FIG. 31 is a partial detailed perspective view of the FIG. 30 embodiment of the invention illustrating attachment of the folded band to the watch module;

FIG. 32 is a perspective view of the FIG. 30 embodiment of the invention illustrating a variant in the band retaining mechanism; and

FIG. 33 is a perspective view of the FIG. 30 embodiment of the invention illustrating another variant in the band retaining mechanism having an angled retaining member.

### DETAILED DESCRIPTION OF THE PREFERRED EMBODIMENT

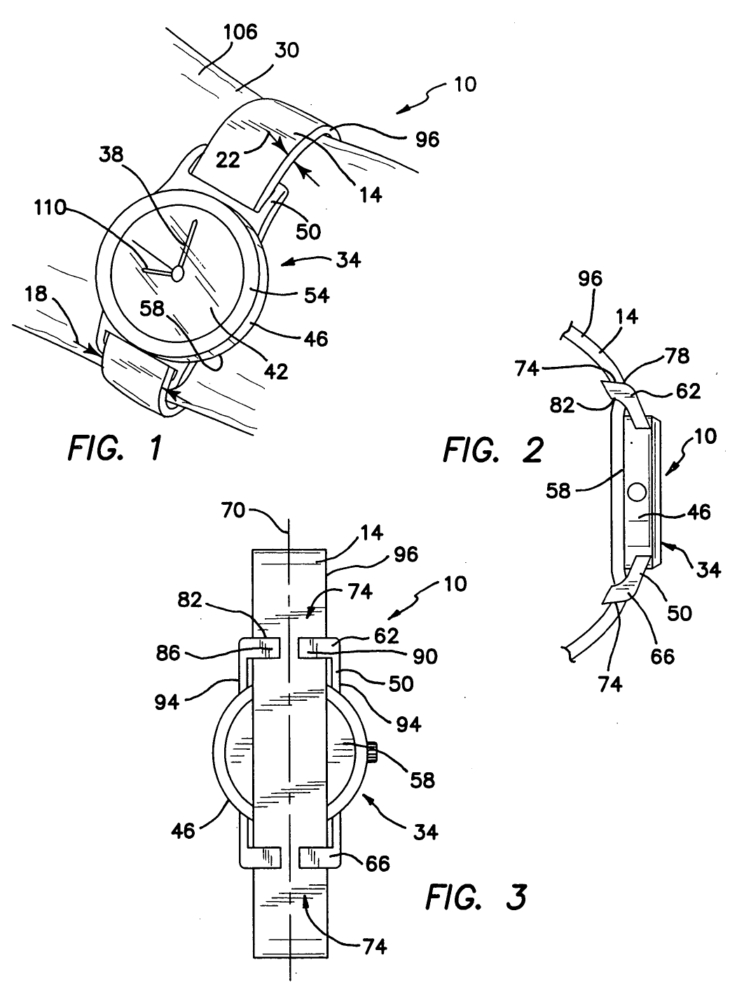

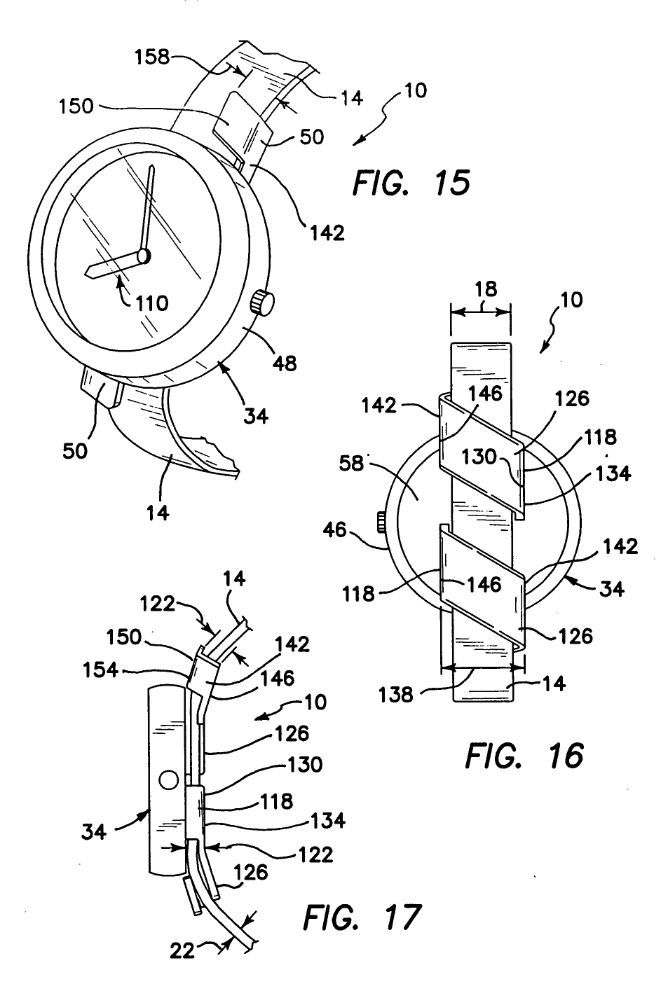

(1) A flexible band with clip-on watch 10, as illustrated in FIGS. 1-33, providing all of the desired features can be constructed from the following components. At least one flexible, continuous band 14 is provided. The band 14 has a first predetermined width 18 and a first predetermined thickness 22, is formed of resilient material and is sized and shaped to fit stretchably over a wearer's hand (not shown) and loosely about the wearer's wrist 30. A watch module 34 is provided. The watch module 34 includes a time-keeping movement 38, a display 42, a surrounding case 46, and an attachment mechanism 50. The case 46 has an upper surface 54 and a lower surface 58. The attachment mechanism 50 removably joins the watch module 34 to the band 14.

(2) In a variant of the invention, as illustrated in FIGS. 1-3, the attachment mechanism 50 further includes first 62 and second 66 retaining clips. Each of the clips 62, 66 extends outwardly from the surrounding case 46 along a diameter 70 of the watch module 34 in opposite directions. Each of the clips 62, 66 has a channel 74 through it. The channel 74 has an upper wall 78, a lower wall 82 and is sized and shaped to fit slidably about the band 14. The lower wall 82 includes first 86 and second 90 opposing prongs. The prongs 86, 90 are located at right angles to the diameter 70 and extend inwardly from outer edges 94 of the clips 62, 66 toward each other. The prongs 86, 90 are spaced apart sufficiently to permit an edge 96 of the band 14 to pass between them. When the edge 96 of the band 14 is passed between each of the sets of prongs 86, 90 and turned to lie flat against the lower surface 58 of the surrounding case 46, the band 14 will be removably attached to the watch module 34.

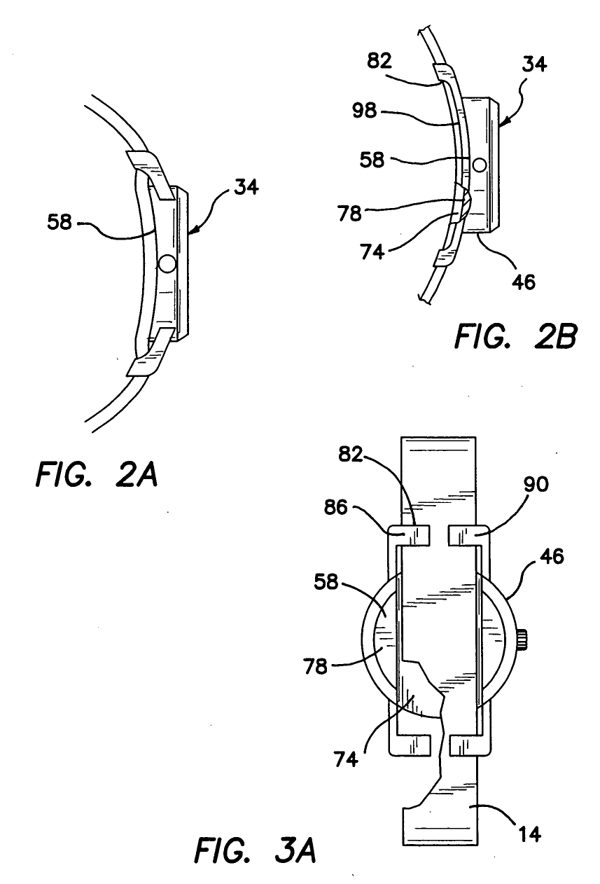

(3) In another variant, as illustrated in FIG. 2B, the watch module 34 further includes a bottom plate 98. The bottom plate 98 is attached to the lower surface 58 of the surrounding case 46 and forms the upper wall 78 of the channel 74. The lower wall 82 includes the first 86 and second 90 opposing prongs descending from side edges 102 of the bottom plate 98.

(4) In still another variant, as illustrated in FIG. 2B, the bottom plate 98 is curved to permit the watch module 34 to fit more closely against the wrist 30 of the wearer 106.

(5) In yet another variant, as illustrated in FIG. 3A, the upper wall 78 of the channel 74 is recessed into the lower surface 58 of the surrounding case 46, thereby permitting the band 14 to fit more closely against the wrist 30 of the wearer 106.

(6) In a further variant, as illustrated in FIG. 1, the watch module 34 includes an analog watch movement 110.

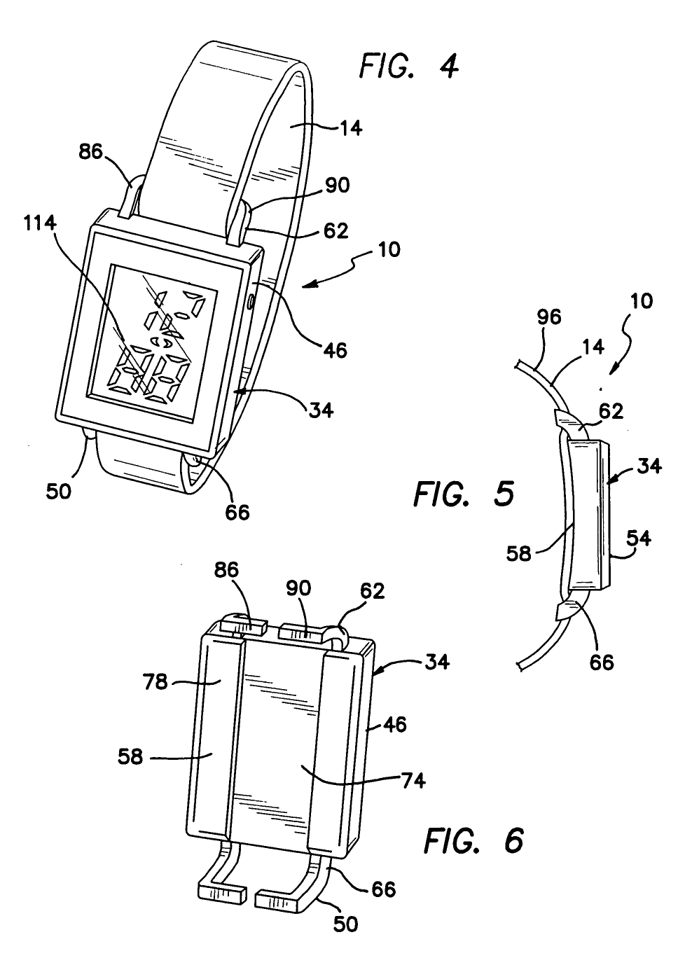

(7) In still a further variant, as illustrated in FIG. 4, the watch module 34 includes a digital watch movement 114.

(8) In yet a further variant, the watch module 34 is waterproof.

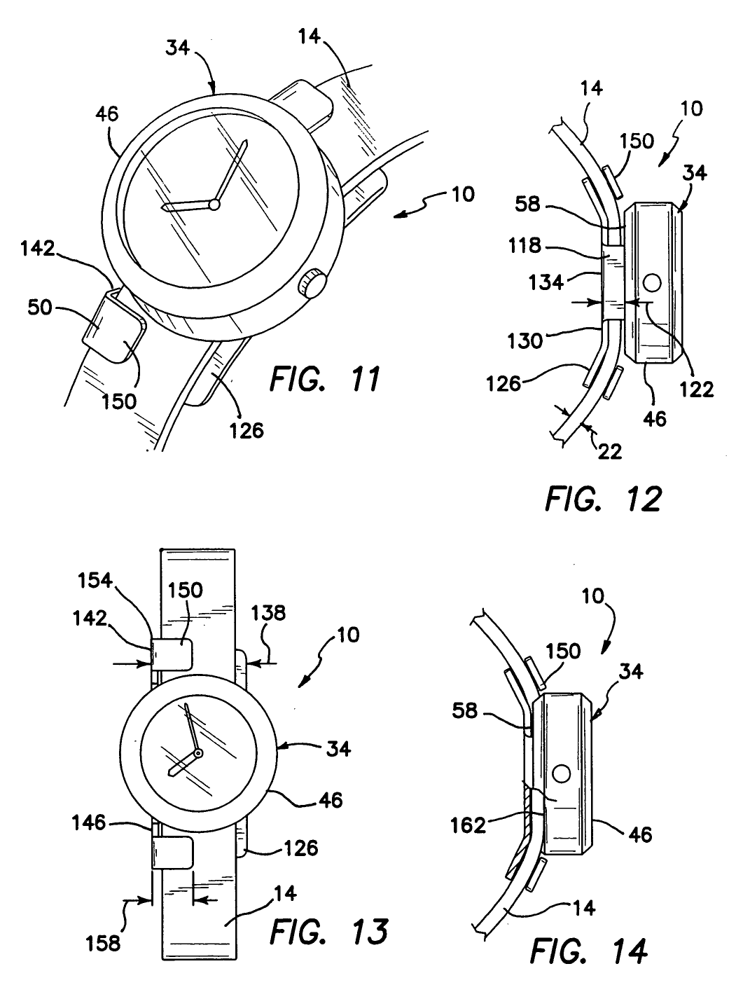

(9) In a variant of the invention, as illustrated in FIGS. 11-17, the attachment mechanism 50 further includes at least one first side wall 118. The first side wall 118 is attached at a right angle to the lower surface 58 of the surrounding case 46 and descends from it for a first predetermined distance 122. At least one underband plate 126 is provided. The plate 126 is attached at a right angle at a proximate edge 130 to a lower edge 134 of the first side wall 118. The plate 126 has a width 138 at least equal to the first predetermined width 18 and is spaced from the lower surface 58 by at least the first predetermined thickness 22. At least one second side wall 142 is provided. The second side wall 142 is attached at a right angle at a distal edge 146 of the underband plate 126 and ascends toward the lower surface 58 for at least the first predetermined distance 122. At least one retaining tab 150 is provided. The retaining tab 150 is attached at a right angle at an upper edge 154 of the second side wall 142 and extends inwardly over the underband plate 126 for a second predetermined distance 158. When the band 14 is inserted between the lower surface 58 of the surrounding case 46 and the underband plate 126 it will be located against the first side wall 118 and when the band 14 is then pushed under the retaining tab 150 it will be located between the first side wall 118 and the second side wall 142, thereby removably attaching the watch module 34 to the band 14.

(10) In another variant, as illustrated in FIGS. 12, 14 and 17, the underband plate 126 is curved to permit the watch module 34 to fit more closely against the wrist 30 of the wearer 106.

(11) In still another variant, as illustrated in FIG. 14, the lower surface 58 of the surrounding case 46 is recessed, thereby providing a space 162 for the band 14 and permitting the watch module 34 to fit more closely against the wrist 30 of the wearer 106.

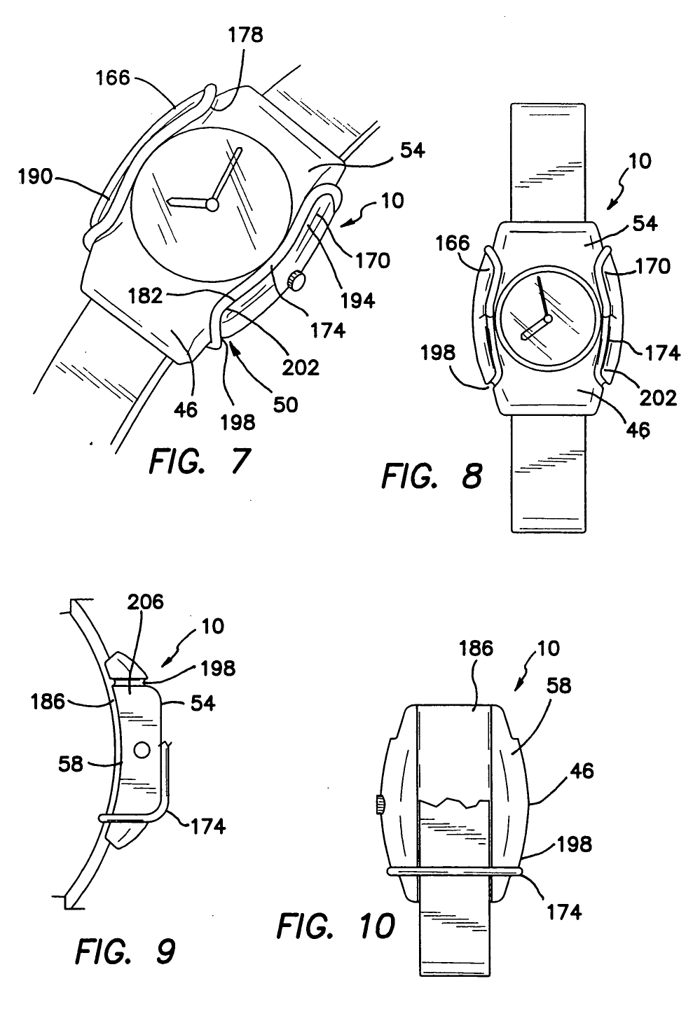

(12) In yet another variant, as illustrated in FIGS. 7-10, the attachment mechanism 50 further includes first 166 and second 170 retaining means. The retaining means 166, 170 extend upwardly from the upper surface 54 of the surrounding case 46. A continuous loop 174 is provided. The loop 174 is formed of resilient material and is sized and shaped to extend from an inner edge 178 of the first retaining means 166, beneath the lower surface 58 of the watch module 34 and the continuous band 14, and over an inner edge 182 of the second retaining means 170, thereby removably attaching the watch module34 to the band 14.

(13) In a further variant, as illustrated in FIGS. 9 and 10, the attachment mechanism 50 further includes a recess 186. The recess 186 is located in the lower surface 58 of the surrounding case 46, is sized and shaped to fit frictionally about the band 14 and permits the watch module 34 to fit more closely against the wrist 30 of the wearer 106.

(14) In still a further variant, as illustrated in FIG. 9, the lower surface 58 of the surrounding case 46 and the recess 186 are curved, thereby permitting the watch 10 to fit more closely against the wrist 30 of the wearer 106.

(15) In yet a further variant, as illustrated in FIG. 7, the retaining means 166, 170 further includes first 190 and second 194 ridges. The ridges 190, 194 are sized and shaped to retain the continuous loop 174.

(16) In another variant of the invention, as illustrated in FIGS. 7-10, the attachment mechanism 50 further includes at least one side notch 198. The side notch 198 extends downwardly from ends 202 of the first 190 and second 194 ridges along side edges 206 of the surrounding case 46. The notches 198 make attachment of the continuous loop 174 more compact.

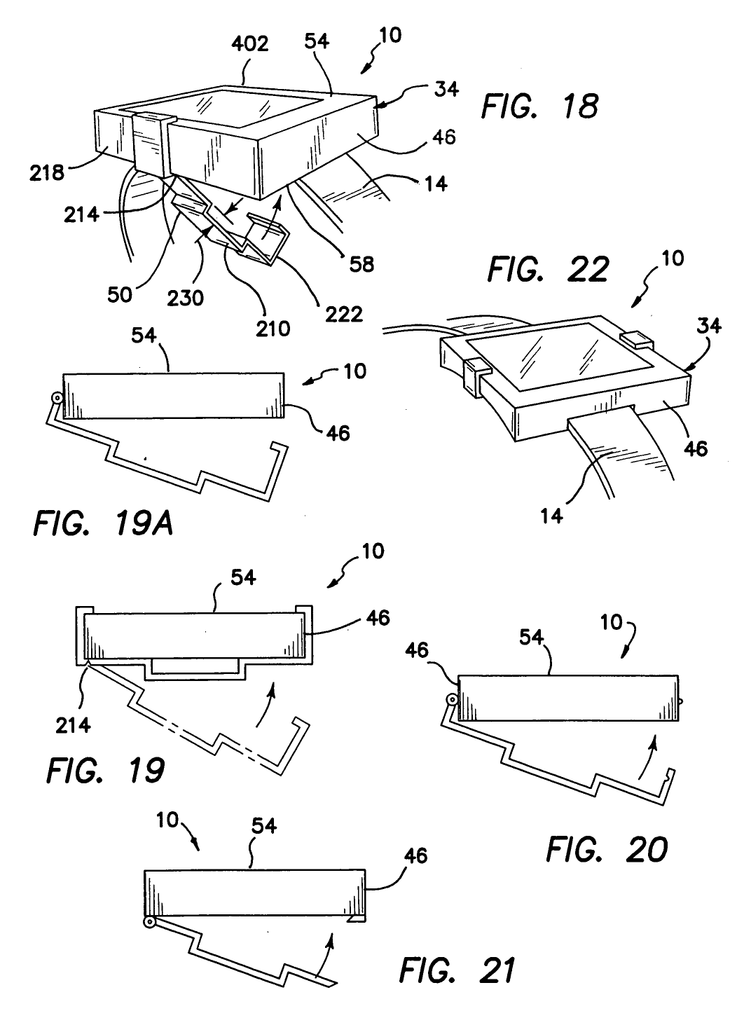

(17) In still another variant, as illustrated in FIGS. 18-22, the attachment mechanism 50 further includes an attachment bracket 210. As illustrated in FIG. 21, the bracket 210 is formed of resilient material, hingedly attached at a first end 214 adjacent a first side 218 of the lower surface 58 of the surrounding case 46 and removably attached at a second end 222 adjacent an opposite second side 226 of the lower surface 58. The bracket 210 is spaced downwardly from the lower surface 58 by a distance 230 slightly less than the first predetermined thickness 22. The bracket 210 bears frictionally against the band 14 when the second end 222 is attached adjacent the opposite second side 226 of the lower surface 58. When the second end 222 of the bracket 210 is detached from adjacent the opposite second side 226, the watch module 34 may be removed from the band 14.

(18) In yet another variant, as illustrated in FIG. 20, the first end 214 of the bracket 210 is hingedly attached at a first point 234 on a first side edge 238 of the surrounding case 46. The bracket 210 descends from the first point 234 below the lower surface 58 of the case 46, extends across the lower surface 58 and ascends to a second point 242 on an opposite second side edge 246 of the case 46. The second end 222 of the bracket 210 is removably attached to the second side edge 246 adjacent the second point 242.

(19) In a further variant, as illustrated in FIG. 22, the attachment mechanism 50 further includes a recess 250. The recess 250 is located in the lower surface 58 of the surrounding case 46, is sized and shaped to fit frictionally about the band 14 and permits the watch module 34 to fit more closely against the wrist 30 of the wearer 106

(20) In still a further variant, as illustrated in FIG. 22, the lower surface 58 of the surrounding case 46 and the recess 250 are curved, thereby permitting the watch 10 to fit more closely against the wrist 30 of the wearer 106.

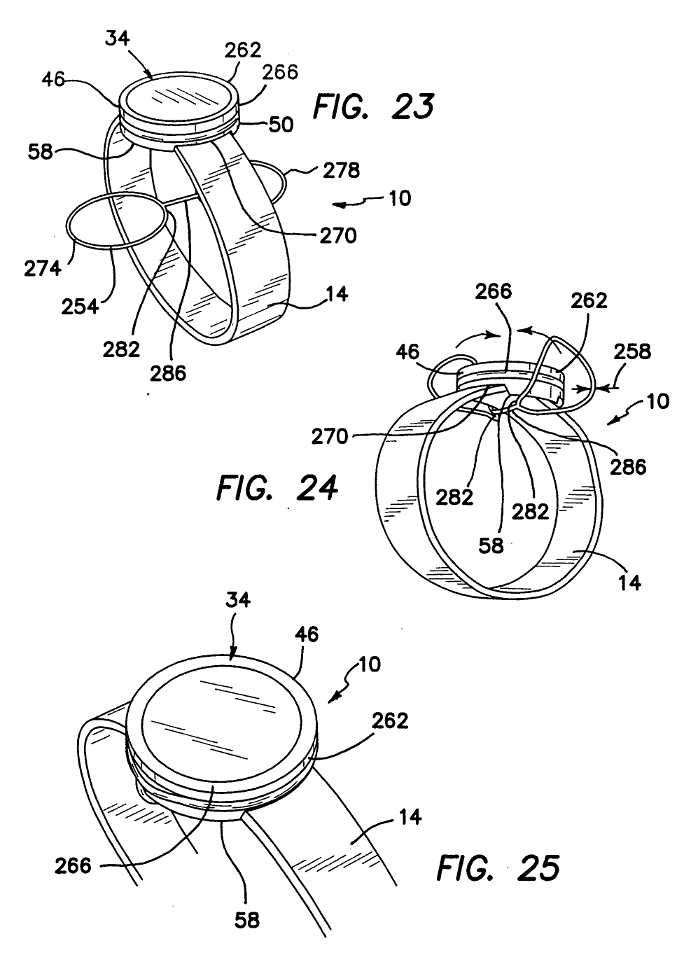

(21) In yet a further variant, as illustrated in FIGS. 23-25, the attachment mechanism 50 further includes an elastic member 254. The member 254 has a first predetermined cross section 258, is sized and shaped to fit elastically about a peripheral edge 262 of the surrounding case 46, under the lower surface 58 of the case 46, across the band 14 and back over the peripheral edge 262. A circumferential groove 266 is provided. The groove 266 is located about the peripheral edge 262 of the surrounding case 46 and is sized and shaped to retain at least one cross section 258 of the elastic member 254. When the elastic member 254 is looped about the circumferential groove 266 and passed under the lower surface 58 of the surrounding case 46, under the band 14 and back up and over the case 46 and stretched over the groove 266, the watch module 34 will be removably attached to the band 14.

(22) In another variant of the invention, as illustrated in FIG. 24, the attachment mechanism 50 further includes a recess 270. The recess 270 is located in the lower surface 58 of the surrounding case 46, is sized and shaped to fit frictionally about the band 14 and permits the watch module 34 to fit more closely against the wrist 30 of the wearer 106.

(23) In still another variant, as illustrated in FIG. 24, the lower surface 58 of the surrounding case 46 and the recess 270 are curved, thereby permitting the watch 10 to fit more closely against the wrist 30 of the wearer 106.

(24) In yet another variant, as illustrated in FIGS. 23-25, the elastic member 254 includes two circular portions 274, 278. The circular portions 274 are sized and shaped to fit elastically about the circumferential groove 266. The circular portions 274 are joined at their peripheral edges 282 by at least one straight member 286. The straight member 286 is sized to extend elastically from the first circular portion 274, under the lower surface 58 of the surrounding case 46, under the band 14 and back to the peripheral edge 282 of the second circular portion 278.

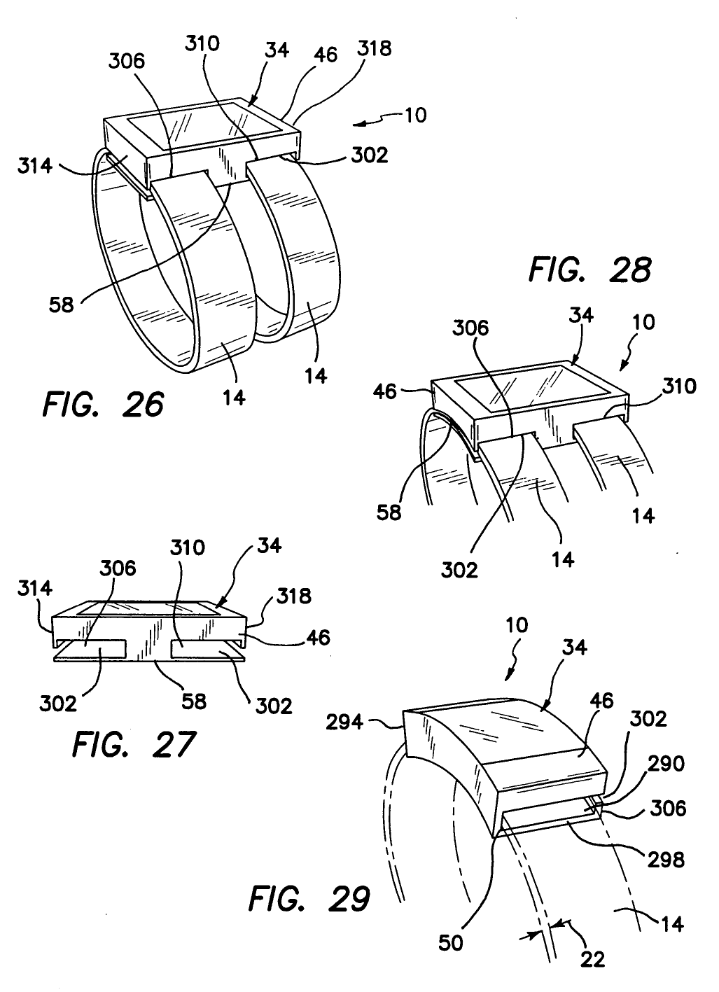

(25) In a further variant, as illustrated in FIGS. 26-29, the attachment mechanism 50 further includes at least one slot 290. The slot 290 extends from a front edge 294 of the surrounding case 46 to a rear edge 298 of the case 46, has an opening 302 at a side edge 306 of the case 46 and is sized and shaped to fit frictionally about the band 14. When the band 14 is inserted into the slot 290, the watch module 34 will be removably attached to the band 14.

(26) In still a further variant, the opening 302 is slightly smaller than the first predetermined thickness 22. When the band 14 is inserted into the slot 290, slight pressure will be required to force the band 14 past the opening 302 and into the slot 290, thereby securing the watch module 34 to the band 14.

(27) In yet a further variant, as illustrated in FIGS. 26-28, the attachment mechanism 50 further includes first 306 and second 310 parallel slots. The slots 306, 310 are located above the lower surface 58 of the surrounding case 46. Each of the slots 306, 310 has an opening 302 at an adjacent side edge 314, 318 of the case 46. Two bands 14 are provided. Each of the bands 14 is disposed in one of the first 306 and second 310 slots.

(28) In another variant of the invention, as illustrated in FIGS. 28 and 29, the lower surface 58 of the surrounding case 46 is curved, thereby permitting the watch 10 to fit more closely against the wrist 30 of the wearer 106.

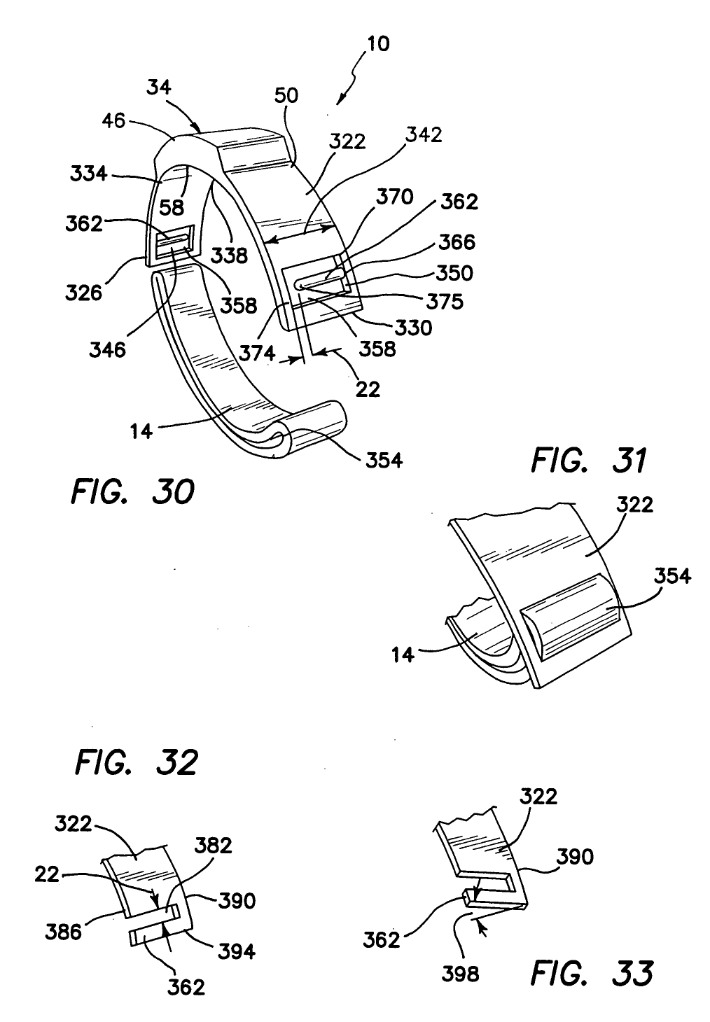

(29) In still another variant, as illustrated in FIGS. 30 and 31, the attachment mechanism 50 further includes a curved support platform 322. The platform 322 has a first end 326 and a second end 330. Each of the ends 326, 330 extends outwardly adjacent first 334 and second 338 side edges of the lower surface 58 of the surrounding case 46, is curved to conform to the wrist 30 of the wearer 106, and has a width 342 at least equal to the first predetermined width 18. First 346 and second 350 attachment notches are provided. Each of the notches 346, 350 is located adjacent one of the first 326 and second 330 ends of the support platform 322 and is sized and shaped to retain a folded loop 354 of the flexible, continuous band 14. When a folded loop 354 of the band 14 is inserted into to each of the first 346 and second 350 attachment notches, the watch module 34 will be removably attached to the folded band 14.

(30) In yet another variant, each of the attachment notches 346, 350 includes an aperture 358 located adjacent each of the first 326 and second 330 ends of the support platform 322. A retaining member 362 is provided. The retaining member 362 extends from a proximal end 366 attached to a lateral inside edge 370 of the aperture 358 toward an opposite lateral inside edge 374. A distal end 378 of the retaining member 362 is spaced from the opposite edge 374 by at least the first predetermined thickness 22. When the folded loop 354 of the flexible, continuous band 14 is inserted into each of the apertures 358 and about the retaining member 362, the watch module 34 will be removably attached to the folded band 14.

(31) In a further variant, as illustrated in FIG. 32, each of the attachment notches 346, 350 includes an opening 382. The opening 382 extends from a first edge 386 of the curved support platform 322 toward a second opposite edge 390 of the platform 322. The opening 382 defines a retaining member 362 disposed at a distal end 394 of the support platform 322, the retaining member 362 is spaced outwardly from the opening 382 by at least the first predetermined thickness 22. When the folded loop 354 of the flexible, continuous band 14 is disposed through the opening 382 and about each of the retaining members 362 the watch module 34 will be removably attached to the folded band 14.

(32) In still a further variant of the invention, as illustrated in FIG. 33, each of the retaining members 362 is attached to the second edge 390 of the support platform 322 at an acute angle 398, thereby more securely attaching the watch module 34 to the folded band 14.

(33) In yet a further variant, as illustrated in FIGS. 18, 19 and 22, the attachment mechanism 50 further includes an attachment bracket 210. The bracket 210 is formed of resilient material, hingedly attached at a first end 214 adjacent a first side 218 of the lower surface 58 of the surrounding case 46 and removably attached at a second end 222 adjacent an opposite second side 402 of the upper surface 54 of the case 46. The bracket 210 is spaced downwardly from the lower surface 58 by a distance 230 slightly less than the first predetermined thickness 22. The bracket 210 bears frictionally against the band 14 when the second end 222 is attached adjacent the opposite second side 402 of the upper surface 54. When the second end 222 of the bracket 210 is detached from adjacent the opposite second side 402, the watch module 30 may be removed from the band 14.

(34) In another variant, as illustrated in FIG. 19A, the first end 214 of the bracket 210 is hingedly attached at a first point 234 on the first side edge 238 of the surrounding case 46. The bracket 210 descends from the first point 234 below the lower surface 58 of the case 46, extends across the lower surface 58 and ascends to a second point 406 on an opposite second side 402 of the upper surface 54 of the case 46. The second end 222 of the bracket 210 is removably attached to the upper surface 54 adjacent the second point 406

(35) In still another variant, as illustrated in FIG. 22, the attachment mechanism 50 further includes a recess 250. The recess 250 is located in the lower surface 58 of the surrounding case 46, is sized and shaped to fit frictionally about the band 14 and permits the watch module 34 to fit more closely against the wrist 30 of the wearer 106

(36) In a final variant of the invention, as illustrated in FIG. 22, the lower surface 58 of the surrounding case 46 and the recess 250 are curved, thereby permitting the watch 10 to fit more closely against the wrist 30 of the wearer 106.

1. A flexible band with clip-on watch comprising:
At least one flexible, continuous band, said band having a first predetermined width and a first predetermined thickness, being formed of resilient material and being sized and shaped to fit stretchably over a wearer's hand and loosely about said wearer's wrist;
a watch module, said watch module comprising a time-keeping movement, a display, a surrounding case, and an attachment mechanism, said case having an upper surface and a lower surface; and
said attachment mechanism removably joining said watch module to said at least one band.

2. The flexible band with clip-on watch, as described in claim 1, wherein said attachment mechanism further comprises:
first and second retaining clips, each of said clips extending outwardly from said surrounding case along a diameter of said watch module in opposite directions;
each of said clips having a channel therethrough, said channel having an upper wall, a lower wall and being sized and shaped to fit slidably about said band;
said lower wall comprising first and second opposing prongs, said prongs being disposed orthogonally to said diameter and extending inwardly from outer edges of said clips toward each other;
said prongs being spaced apart sufficiently to permit an edge of said band to pass between said prongs; and
whereby, when said edge of said band is passed between each of said set of prongs and turned to lie flat against said lower surface of said surrounding case, said band will be removably attached to said watch module.

3. The flexible band with clip-on watch, as described in claim 2, wherein said watch module further comprises:
a bottom plate, said bottom plate being attached to said lower surface of said surrounding case and forming said upper wall of said channel; and
said lower wall comprising said first and second opposing prongs descending from side edges of said bottom plate.

4. The flexible band with clip-on watch, as described in claim 3, wherein said bottom plate is curved to permit said watch module to fit more closely against said wrist of said wearer.

5. The flexible band with clip-on watch, as described in claim 2, wherein said upper wall of said channel is recessed into said lower surface of said surrounding case, thereby permitting said band to fit more closely against said wrist of said wearer.

6. The flexible band with clip-on watch, as described in claim 1, wherein said watch module comprises an analog watch movement.

7. The flexible band with clip-on watch, as described in claim 1, wherein said watch module comprises a digital watch movement.

8. The flexible band with clip-on watch, as described in claim 1, wherein said watch module is waterproof.

9. The flexible band with clip-on watch, as described in claim 1, wherein said attachment mechanism further comprises:
at least one first side wall, said first side wall being orthogonally attached to said lower surface of said surrounding case and descending therefrom for a first predetermined distance;
at least one underband plate, said plate being orthogonally attached at a proximate edge to a lower edge of said first side wall, having a width at least equal to said first predetermined width and being spaced from said lower surface by at least said first predetermined thickness;
at least one second side wall, said second side wall being orthogonally attached at a distal edge of said at least one underband plate and ascending toward said lower surface for at least said first predetermined distance;
at least one retaining tab, said retaining tab being orthogonally attached at an upper edge of said second side wall and extending inwardly over said underband plate for a second predetermined distance; and
whereby, when said band is inserted between said lower surface of said surrounding case and said at least one underband plate it will be disposed against said at least one first side wall and when said band is then pushed under said at least one retaining tab it will be disposed between said at least one first side wall and said at least one second side wall, thereby removably attaching said watch module to said band.

10. The flexible band with clip-on watch, as described in claim 9, wherein said underband plate is curved to permit said watch module to fit more closely against said wrist of said wearer.

11. The flexible band with clip-on watch, as described in claim 9, wherein said lower surface of said surrounding case is recessed, thereby providing a space for said band and permitting said watch module to fit more closely against said wrist of said wearer.

12. The flexible band with clip-on watch, as described in claim 1, wherein said attachment mechanism further comprises:
first and second retaining means, said retaining means extending upwardly from said upper surface of said surrounding case;
a continuous loop, said loop being formed of resilient material and being sized and shaped to extend from an inner edge of said first retaining means, beneath said lower surface of said watch module and said continuous band, and over an inner edge of said second retaining means, thereby removably attaching said watch module to said band.

13. The flexible band with clip-on watch, as described in claim 12, wherein said attachment mechanism further comprises a recess, said recess being disposed in said lower surface of said surrounding case, being sized and shaped to fit frictionally about said band and permitting said watch module to fit more closely against said wrist of said wearer.

14. The flexible band with clip-on watch, as described in claim 13, wherein said lower surface of said surrounding case and said recess are curved, thereby permitting said watch to fit more closely against said wrist of said wearer.

15. The flexible band with clip-on watch, as described in claim 12, wherein said retaining means further comprises first and second ridges, said ridges being sized and shaped to retain said continuous loop.

16. The flexible band with clip-on watch, as described in claim 15, wherein said attachment mechanism further comprises at least one side notch, said side notch extending downwardly from ends of said first and second ridges along side edges of said surrounding case, said notches making attachment of said continuous loop more compact.

17. The flexible band with clip-on watch, as described in claim 1, wherein said attachment mechanism further comprises:
an attachment bracket, said bracket being formed of resilient material, hingedly attached at a first end adjacent a first side of said lower surface of said surrounding case and removably attached at a second end adjacent an opposite second side of said lower surface;
said bracket being spaced downwardly from said lower surface by a distance slightly less than said first predetermined thickness;
said bracket bearing frictionally against said band when said second end is attached adjacent said opposite second side of said lower surface; and
whereby, when said second end of said bracket is detached from adjacent said opposite second side, said watch module may be removed from said band.

18. The flexible band with clip-on watch, as described in claim 17, wherein:
said first end of said bracket is hingedly attached at a first point on a first side edge of said surrounding case;
said bracket descends from said first point below said lower surface of said case, extends across said lower surface and ascends to a second point on an opposite second side edge of said case; and
said second end of said bracket being removably attached to said second side edge adjacent said second point.

19. The flexible band with clip-on watch, as described in claim 17, wherein said attachment mechanism further comprises a recess, said recess being disposed in said lower surface of said surrounding case, being sized and shaped to fit frictionally about said band and permitting said watch module to fit more closely against said wrist of said wearer.

20. The flexible band with clip-on watch, as described in claim 19, wherein said lower surface of said surrounding case and said recess are curved, thereby permitting said watch to fit more closely against said wrist of said wearer.

21. The flexible band with clip-on watch, as described in claim 1, wherein said attachment mechanism further comprises:
an elastic member, said member having a first predetermined cross section, being sized and shaped to fit elastically about a peripheral edge of said surrounding case, under said lower surface of said case, across said band and back over said peripheral edge;
a circumferential groove, said groove being disposed about said peripheral edge of said surrounding case and being sized and shaped to retain at least one cross section of said elastic member; and
whereby, when said elastic member is looped about said circumferential groove and passed under said lower surface of said surrounding case, under said band and back up and over said case and stretched over said groove, said watch module will be removably attached to said band.

22. The flexible band with clip-on watch, as described in claim 21, wherein said attachment mechanism further comprises a recess, said recess being disposed in said lower surface of said surrounding case, being sized and shaped to fit frictionally about said band and permitting said watch module to fit more closely against said wrist of said wearer.

23. The flexible band with clip-on watch, as described in claim 22, wherein said lower surface of said surrounding case and said recess are curved, thereby permitting said watch to fit more closely against said wrist of said wearer.

24. The flexible band with clip-on watch, as described in claim 21, wherein:
said elastic member comprises two circular portions, said circular portions being sized and shaped to fit elastically about said circumferential groove; and
said circular portions being joined at their peripheral edges by at least one straight member, said straight member being sized to extend elastically from said first circular portion, under said lower surface of said surrounding case, under said band and back to said peripheral edge of said second circular portion.

25. The flexible band with clip-on watch, as described in claim 1, wherein said attachment mechanism further comprises:
at least one slot, said slot extending from a front edge of said surrounding case to a rear edge of said case, having an opening at a side edge of said case and being sized and shaped to fit frictionally about said band; and
whereby, when said band is inserted into said slot, said watch module will be removably attached to said band.

26. The flexible band with clip-on watch, as described in claim 25 wherein:
said opening is slightly smaller than said first predetermined thickness; and
whereby, when said band is inserted into said slot, slight pressure will be required to force said band past said opening and into said slot, thereby securing said watch module to said band.

27. The flexible band with clip-on watch, as described in claim 25 wherein said attachment mechanism further comprises:
first and second parallel slots, said slots being disposed above said lower surface of said surrounding case;
each of said slots having an opening at an adjacent side edge of said case; and
two bands, each of said bands being disposed in one of said first and second slots.

28. The flexible band with clip-on watch, as described in claim 25 wherein said lower surface of said surrounding case is curved, thereby permitting said watch to fit more closely against said wrist of said wearer.

29. The flexible band with clip-on watch, as described in claim 1, wherein said attachment mechanism further comprises:
a curved support platform, said platform having a first end and a second end, each of said ends extending outwardly adjacent first and second side edges of said lower surface of said surrounding case, being curved to conform to said wrist of said wearer, and having a width at least equal to said first predetermined width;
first and second attachment notches, each of said notches disposed adjacent one of said first and second ends of said support platform and being sized and shaped to retain a folded loop of said flexible, continuous band; and
whereby, when a folded loop of said band is inserted into to each of said first and second attachment notches, said watch module will be removably attached to said folded band.

30. The flexible band with clip-on watch, as described in claim 29, wherein each of said attachment notches comprises:
an aperture disposed adjacent each of said first and second ends of said support platform;
a retaining member extending from a proximal end attached to a lateral inside edge of said aperture toward an opposite lateral inside edge, a distal end of said retaining member being spaced from said opposite edge by at least said first predetermined thickness; and
whereby, when said folded loop of said flexible, continuous band is inserted into each of said apertures and about said retaining member, said watch module will be removably attached to said folded band.

31. The flexible band with clip-on watch, as described in claim 29, wherein each of said attachment notches comprises;
an opening, said opening extending from a first edge of said curved support platform toward a second opposite edge of said platform, defining a retaining member disposed at a distal end of said support platform, said retaining member being spaced outwardly from said opening by at least said first predetermined thickness; and
whereby, when said folded loop of said flexible, continuous band is disposed through said opening and about each of said retaining members said watch module will be removably attached to said folded band.

32. The flexible band with clip-on watch, as described in claim 31, wherein each of said retaining members is attached to said second edge of said support platform at an acute angle, thereby more securely attaching said watch module to said folded band.

33. The flexible band with clip-on watch, as described in claim 1, wherein said attachment mechanism further comprises:
an attachment bracket, said bracket being formed of resilient material, hingedly attached at a first end adjacent a first side of said lower surface of said surrounding case and removably attached at a second end adjacent an opposite second side of said upper surface of said case;
said bracket being spaced downwardly from said lower surface by a distance slightly less than said first predetermined thickness;
said bracket bearing frictionally against said band when said second end is attached adjacent said opposite second side of said upper surface; and
whereby, when said second end of said bracket is detached from adjacent said opposite second side, said watch module may be removed from said band. (Snap Clip)

34. The flexible band with clip-on watch, as described in claim 33, wherein:
said first end of said bracket is hingedly attached at a first point on said first side edge of said surrounding case;
said bracket descends from said first point below said lower surface of said case, extends across said lower surface and ascends to a second point on an opposite second side of said upper surface of said case; and
said second end of said bracket being removably attached to said upper surface adjacent said second point. (Snap Clip)

35. The flexible band with clip-on watch, as described in claim 33, wherein said attachment mechanism further comprises a recess, said recess being disposed in said lower surface of said surrounding case, being sized and shaped to fit frictionally about said band and permitting said watch module to fit more closely against said wrist of said wearer. (Snap Clip)

36. The flexible band with clip-on watch, as described in claim 33, wherein said lower surface of said surrounding case and said recess are curved, thereby permitting said watch to fit more closely against said wrist of said wearer. (Snap Clip)
